(19) United States
(12) Patent Application Publication
(10) Pub. No.: US 2015/0291859 A1
(43) Pub. Date: Oct. 15, 2015

(54) PRESSURE-SENSITIVE ADHESIVE TAPE FOR ELECTROCHEMICAL DEVICE

(71) Applicant: NITTO DENKO CORPORATION, Ibaraki-shi, Osaka (JP)

(72) Inventors: Yuichi Takamura, Ibaraki-shi (JP); Shigeki Kawabe, Ibaraki-shi (JP); Hiroomi Hanai, Ibaraki-shi (JP)

(73) Assignee: NITTO DENKO CORPORATION, Ibaraki-shi, Osaka (JP)

(21) Appl. No.: 14/439,339

(22) PCT Filed: Oct. 25, 2013
(86) PCT No.: PCT/JP2013/078940

§ 371 Date: Apr. 29, 2015

(30) Foreign Application Priority Data
Nov. 5, 2012 (JP) 2012-243542

(51) Int. Cl. C09J 133/08; C09J 7/02; H01M 4/66; H01M 4/131; H01M 4/04; H01M 4/139

(52) U.S. Cl. CPC C09J 133/08; H01M 4/0404; H01M 4/139; H01M 4/661; H01M 4/131; C09J 7/0217; H01M 10/052

(57) ABSTRACT

Provided is a pressure-sensitive adhesive tape for electrochemical devices according to the present invention. The adhesive tape is for use in electrochemical device production and includes a substrate and a pressure-sensitive adhesive layer. The adhesive layer is disposed on or over at least one side of the substrate and contains an acrylic polymer as a base polymer. The adhesive tape has a first and a second 180° peel adhesion strength. The first 180° peel adhesion strength is measured at 25° C. and a peeling speed of 300 mm/min after bonded to a SUS 304BA plate at a temperature of from 40° C. to below 150° C. The second 180° peel adhesion strength is measured at 25° C. and a peeling speed of 300 mm/min after bonded to a SUS 304BA plate at 25° C. The first 180° peel adhesion strength is twice or more as high as the second 180° peel adhesion strength.

### TECHNICAL FIELD

The present invention relates to pressure-sensitive adhesive tapes for use in the production of electrochemical devices; and to methods for producing electrochemical devices using the pressure-sensitive adhesive tapes. The electrochemical devices are exemplified by lithium-ion batteries, fuel cells, solar cells, electrolytic capacitors, and electric double layer capacitors.

### BACKGROUND ART

Lithium-ion batteries each structurally include three layers, i.e., a cathode (positive electrode), a separator, and an anode (negative electrode); and an electrolyte around the three layers. The electrodes are each generally prepared by initially applying an active material to a current collector. Typically, the cathode is prepared by applying a cathode active material such as lithium cobaltate to an aluminum foil current collector. Then a pressure-sensitive adhesive tape is applied to a boundary area between a portion coated with the active material and an uncoated portion so as to prevent the active material from being detached. This is because the detachment of the active material impairs the properties of the electrolyte and causes the battery to have inferior properties and/or a shorter cycle life.

According to a conventional method, the electrodes have each been prepared by applying an active material to a large-sized current collector, cutting the resulting article to a desired size, and applying a pressure-sensitive adhesive tape to a boundary area between a portion coated with the active material and an uncoated portion (e.g., Patent Literature (PTL) 1). The method, however, offers poor working efficiency. For better working efficiency, another method has been attempted. In this method, a pressure-sensitive adhesive tape is applied before cutting, and the resulting article is cut to a desired size. Disadvantageously, this attempt has resulted in inferior working efficiency contrarily, because the adhesive of the pressure-sensitive adhesive tape adheres to and stains a cutting blade, and it takes a long time to remove the stain from the cutting blade.

### CITATION LIST

### Patent Literature

PTL 1: Japanese Unexamined Patent Application Publication (JP-A) No. 2002-042881

### SUMMARY OF INVENTION

### Technical Problem

Accordingly, it is an object of the present invention to provide a pressure-sensitive adhesive tape for electrochemical devices, which is for use in an electrochemical device so as typically to prevent an active material from being detached, and which less causes the adherence or deposition of a pressure-sensitive adhesive onto a cutting blade even upon cutting.

It is another object of the present invention to provide a pressure-sensitive adhesive tape for electrochemical devices, which is for use in an electrochemical device so as typically to prevent an adhesive material from being detached, which, when applied, can temporarily fix the active material so as to prevent misregistration from occurring, and which less causes the adherence or deposition of a pressure-sensitive adhesive onto a cutting blade even upon cutting.

It is yet another object of the present invention to provide a method for producing an electrochemical device using the pressure-sensitive adhesive tape for electrochemical devices.

### Solution to Problem

After intensive investigations to achieve the objects, the present inventors have found a pressure-sensitive adhesive tape having a first adhesion strength upon peeling at an angle of 180-degree and a second adhesion strength upon peeling at an angle of 180-degree, the first adhesion strength being twice or more as high as the second adhesion strength, where the first adhesion strength is measured after pressure-bonding at a temperature of from 40° C. to below 150° C., and the second adhesion strength is measured after pressure-bonding at 25° C. The present inventors have found as follows. Assume that the pressure-sensitive adhesive tape is bonded to an area across the boundary between a portion coated with an active material and an uncoated portion in the production of a lithium-ion battery so as to prevent the active material from being detached. In this case, the pressure-sensitive adhesive tape, when applied by thermopressure-bonding (pressure-bonding with heating), can exhibit a high adhesive strength to prevent the active material from being detached. Further assume that the resulting article after the thermopressure-bonding is cut at room temperature. In this case, the article can be cut with less causing the pressure-sensitive adhesive to deposit or stick onto the cutting blade. This enables efficient production of the lithium-ion battery by a specific method. In the method, a large-sized current collector is partially coated with the active material, the pressure-sensitive adhesive tape is applied to a boundary area of a portion coated with the active material and an uncoated portion, and the resulting article is cut to a desired size. The present invention has been made based on these findings.

Specifically, the present invention provides, in one aspect, a pressure-sensitive adhesive tape for electrochemical devices, which is for use in electrochemical device production. The pressure-sensitive adhesive tape includes a substrate and a pressure-sensitive adhesive layer. The pressure-sensitive adhesive layer is disposed on or over at least one side of the substrate and contains an acrylic polymer as a base polymer. The pressure-sensitive adhesive tape has a first 180° peel adhesion strength and a second 180° peel adhesion strength. The first 180° peel adhesion strength is measured at a peeling temperature of 25° C. and a peeling speed of 300 mm/min after pressure-bonding of the tape to a SUS 304BA plate at a temperature of from 40° C. to below 150° C. The second 180° peel adhesion strength is measured at a peeling temperature of 25° C. and a peeling speed of 300 mm/min after pressure-bonding of the tape to a SUS 304BA plate at 25° C. The first 180° peel adhesion strength is twice or more as high as the second 180° peel adhesion strength.

The acrylic polymer is preferably derived from monomer components including one or more monomers each of which gives a homopolymer having a glass transition temperature of 10° C. or higher, where a total content of the one or more monomers is 5 percent by weight or more based on the total amount (100 percent by weight) of the monomer components.

The acrylic polymer is preferably derived from monomer components including one or more monomers each of which gives a homopolymer having a glass transition temperature of below 10° C., where a total content of such one or more monomers is from 65 to 94 percent by weight based on the total amount (100 percent by weight) of the monomer components.

The acrylic polymer is preferably derived from monomer components including one or more carboxy group-containing monomers, where a total content of the one or more carboxy group-containing monomers is 2 percent by weight or more based on the total amount (100 percent by weight) of the monomer components.

The present invention provides, in another aspect, a method for producing an electrochemical device. The method includes the steps 1, 2, and 3, as follows.

In the step 1, a current collector is partially coated with an active material to give an active material-current collector composite.

In the step 2, the pressure-sensitive adhesive tape mentioned above is pressure-bonded to an area across the boundary between a portion coated with the active material and an uncoated portion in the active material-current collector composite, where the pressure-bonding is performed at a temperature of from 40° C. to below 150° C.

In the step 3, the active material-current collector composite is cut and/or blanked, where the composite bears the pressure-bonded pressure-sensitive adhesive tape for electrochemical devices.

In addition and advantageously, the present invention provides an electrochemical device produced by the method mentioned above for producing an electrochemical device.

### Advantageous Effects of Invention

The pressure-sensitive adhesive tape for electrochemical devices according to the present invention, when applied by thermopressure-bonding, can exhibit a high adhesive strength and, at room temperature, resists the adherence or deposition of a pressure-sensitive adhesive onto a cutting blade even upon cutting. This allows extremely efficient production of an electrochemical device without staining the cutting blade in a production process of the electrochemical device. Specifically, the efficient production may be achieved by coating a large-sized current collector with an active material, thermopressure-bonding the pressure-sensitive adhesive tape for electrochemical devices according to the present invention to a boundary area between a portion coated with the active material and an uncoated portion, and cutting the resulting current collector to a desired size at room temperature.

### BRIEF DESCRIPTION OF DRAWINGS

FIG. 1 is a schematic cross-sectional view of a pressure-sensitive adhesive tape for electrochemical devices according to an embodiment of the present invention.

FIG. 2 is a schematic cross-sectional view of a pressure-sensitive adhesive tape for electrochemical devices according to another embodiment of the present invention.

FIG. 3 is a schematic diagram illustrating a method for producing an electrochemical device according to an embodiment of the present invention.

FIG. 4 is a diagram illustrating how to determine a glass transition temperature (Tg) based on a measured result of differential scanning calorimetry (DSC).

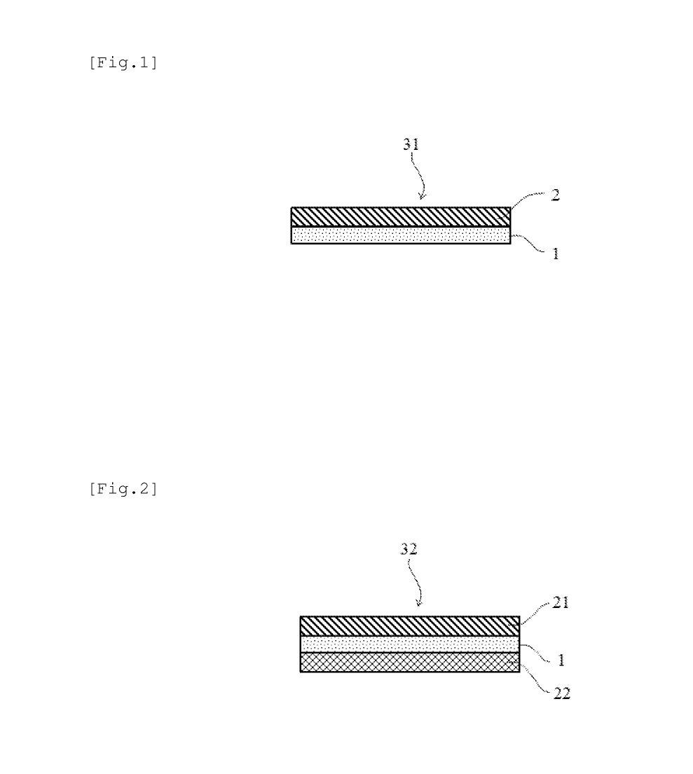

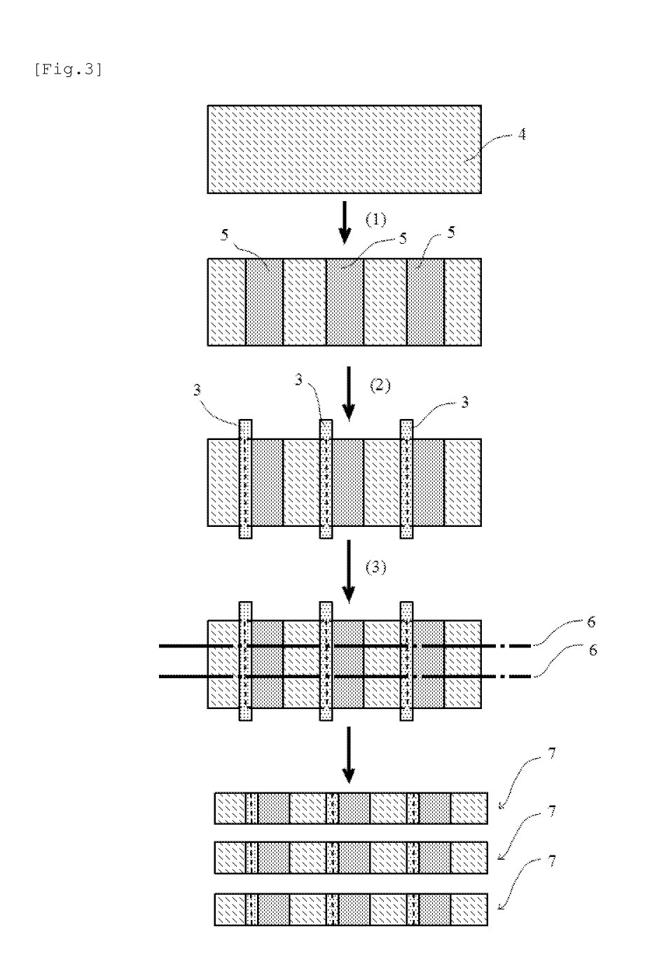

### DESCRIPTION OF EMBODIMENTS

The pressure-sensitive adhesive tape for electrochemical devices according to the present invention includes a substrate and a pressure-sensitive adhesive layer. The pressure-sensitive adhesive layer is disposed on or over at least one side of the substrate and contains an acrylic polymer as a base polymer.

Pressure-Sensitive Adhesive Layer

The pressure-sensitive adhesive layer for use in the present invention includes an acrylic pressure-sensitive adhesive. The acrylic pressure-sensitive adhesive refers to a pressure-sensitive adhesive containing an acrylic polymer as a base polymer.

The acrylic polymer preferably contains a high-Tg monomer and a low-Tg monomer as monomer components constituting the polymer. The “high-Tg monomer” refers to a monomer that gives a homopolymer having a glass transition temperature Tg of 10° C. or higher, preferably 30° C. or higher, and particularly preferably 100° C. or higher. The “low-Tg monomer” refers to a monomer that gives a homopolymer having a glass transition temperature Tg of below 10° C., preferably from −82° C. to 8° C., and particularly preferably from −75° C. to −20° C. For glass transition temperatures Tg, reference was made to “Akuriru Jushi no Gosei-Sekkei to Shin-Yoto Kaihatsu (in Japanese)” (Table 1, p. 247, Chubu Keiei Kaihatsu Center Shuppan-bu, published on Jul. 1, 1985) and “Nenchaku Handobukku (in Japanese) (3rd Ed.)” (Table 12, p. 29, Japan Adhesive Tape Manufacturers Association (JATMA), published on Oct. 1, 2005). In the case where the glass transition temperature Tg of a polymer is not described in the references, the Tg of the polymer was measured according to Japanese Industrial Standard (JIS) (JIS K 7121:2012; Testing methods for glass transition temperatures of plastics) by differential scanning calorimetry (DSC) under conditions below. When a polymer was thermally decomposed and did not give a glass transition temperature Tg in a test by the method, the glass transition temperature Tg of the polymer was concluded to be 100° C. or higher.

Method for Measuring Tg by DSC

Differential scanning calorimeter: TA Instruments Q200

Measurement speed: 10° C./min

Atmosphere gas: N₂ (50 mL/min)

Sample weight: 3 to 4 mg

As illustrated in FIG. 4, a DSC chart is plotted, and an intersection point of an original base line and a tangent line at an inflection point is defined as the glass transition temperature (Tg). The inflection point is a point on a curve at which the curve changes from being convex (convex upward) to being concave (convex downward).

The homopolymer was prepared in a manner as follows.

An aliquot (100 parts by weight) of a monomer having an unknown glass transition temperature Tg was combined with 0.1 part by weight of 2,2′-azobisisobutyronitrile (AIBN) as an initiator and 100 parts by weight of toluene as a solvent and placed under a nitrogen (N₂) purge for 2 hours. The mixture was then subjected to polymerization at 60° C. for 6 hours and yielded a homopolymer.

Separately, a polyester film (50 μm) having a treated release surface, previously subjected to release treatment, was prepared. The homopolymer was applied to the treated release surface of the polyester film to a dry thickness of 30 μm and dried to yield a sample including solids of the homopolymer.

The high-Tg monomer is exemplified by methyl methacrylate (whose homopolymer has a Tg of 105° C.), vinyl acetate (whose homopolymer has a Tg of 32° C.), acrylic acid (whose homopolymer has a Tg of 106° C.), diethylaminoethyl methacrylate (whose homopolymer has a Tg of 18° C.), butyl methacrylate (whose homopolymer has a Tg of 20° C.), glycidyl methacrylate (whose homopolymer has a Tg of 41° C.), 2-hydroxyethyl methacrylate (whose homopolymer has a Tg of 55° C.), diacetone acrylamide (whose homopolymer has a Tg of 65° C.), 2-hydroxypropyl methacrylate (whose homopolymer has a Tg of 76° C.), acrylonitrile (whose homopolymer has a Tg of 97° C.), styrene (whose homopolymer has a Tg of 100° C.), methacrylic acid (whose homopolymer has a Tg of 130° C.), and acrylamide (whose homopolymer has a Tg of 165° C.); and imides. The imides are exemplified by N-substituted maleimides such as N-cyclohexylmaleimide, N-phenylmaleimide (whose homopolymer has a Tg of 100° C. or higher), and N-(4-aminophenyl)maleimide; and acrylic imides such as N-(2-acryloyloxyethyl)succinimide, N-(2-acryloyloxyethyl)maleimide, N-(2-acryloyloxyethyl)phthalimide, N-(4-acryloyloxybutyl)succinimide, N-(4-acryloyloxybutyl)maleimide, and N-(4-acryloyloxybutyl)phthalimide. Each of them may be used alone or in combination.

The pressure-sensitive adhesive layer for use herein preferably has appropriate stiffness (hardness) at room temperature. This is because this acrylic pressure-sensitive adhesive layer still further less causes the pressure-sensitive adhesive to deposit or stick onto a cutting blade upon cutting at room temperature and can minimize the working efficiency reduction due to the staining of the cutting blade. The acrylic polymer for use herein preferably contains, as the high-Tg monomer, any of monomers containing a heterocyclic structure. The monomers are exemplified by the imides such as N-substituted maleimides and acrylic imides. Among them, monomers having a five- to seven-membered heterocyclic structure are more preferred, and monomers having a nitrogen-containing heterocyclic structure are particularly preferred. The acrylic polymer may contain (be derived from) the monomer or monomers having a heterocyclic structure in a content of typically preferably 5 wt % or more, particularly preferably from 5 to 20 wt %, and most preferably from 7 to 15 wt %, based on the total amount (100 wt %) of monomer components constituting the acrylic polymer.

The low-Tg monomer is exemplified by butyl acrylate (whose homopolymer has a Tg of −55° C.), 2-ethylhexyl acrylate (whose homopolymer has a Tg of −70° C.), isononyl acrylate (whose homopolymer has a Tg of −82° C.), ethyl acrylate (whose homopolymer has a Tg of −22° C.), methyl acrylate (whose homopolymer has a Tg of 8° C.), and 2-hydroxyethyl acrylate (whose homopolymer has a Tg of −15° C.). Each of them may be used alone or in combination.

The acrylic polymer may contain (be derived from), as a monomer component, one or more high-Tg monomers in a total content of typically 5 wt % or more, preferably 5 to 35 wt %, and more preferably 7 to 25 wt %, based on the total amount (100 wt %) of monomer components constituting the acrylic polymer. The acrylic polymer, when containing the high-Tg monomer or monomers in a total content within the above-mentioned range, can impart appropriate stiffness to the pressure-sensitive adhesive. This allows the pressure-sensitive adhesive to resist adherence or deposition onto the cutting blade upon cutting at room temperature and may prevent the working efficiency reduction due to the staining of the cutting blade.

The acrylic polymer may contain (be derived from), as a monomer component, one or more low-Tg monomers in a total content of typically from 65 to 94 wt %, preferably from 70 to 94 wt %, and particularly preferably from 75 to 92 wt %, based on the total amount (100 wt %) of monomer components constituting the acrylic polymer. The acrylic polymer, when containing low-Tg monomer or monomers in a total content within the above-mentioned range, can exhibit such slight adhesiveness as to enable temporary fixing at room temperature and can be once removed and applied again typically when air bubbles are included upon application. This may prevent reduction in yield. In contrast, the acrylic polymer, if containing the low-Tg monomer or monomers in a total content less than the range, may readily cause the pressure-sensitive adhesive tape to achieve temporary fixing with difficulty and to undergo misregistration even with a low impact immediately after the application.

Under certain circumstances, the acrylic polymer may be preferably prepared by copolymerization with one or more carboxy group-containing monomers. In this case, the acrylic polymer has an acid value of preferably 15 KOH-mg/g or more, more preferably from 39 to 156 KOH-mg/g, and particularly preferably from 62 to 140 KOH-mg/g. This helps the pressure-sensitive adhesive tape to have better adhesiveness to metals. The acid value may be adjusted typically by the content of the carboxy group-containing monomer or monomers in the monomer components for constituting the acrylic polymer. The carboxy group-containing monomers are exemplified by (meth)acrylic acid, itaconic acid, maleic acid, fumaric acid, crotonic acid, isocrotonic acid, maleic anhydride, and itaconic anhydride. Each of them may be used alone or in combination. Among them, (meth)acrylic acid is preferably employed. The acid value herein refers to a value determined by neutralization titration in conformity with JIS K 0070:1992.

The acrylic polymer may contain (be derived from) one or more carboxy group-containing monomers in a total content of typically 2 wt % or more, preferably from 5 to 20 wt %, particularly preferably from 8 to 18 wt %, based on the total amount (100 wt %) of monomer components constituting the acrylic polymer.

The acrylic polymer may be prepared by polymerizing the monomer component or components according to a known or common polymerization technique. The polymerization technique is exemplified by solution polymerization, emulsion polymerization, bulk polymerization, and active-energy-ray-polymerization which is performed with the application of an active energy ray. Among them, solution polymerization and active-energy-ray-polymerization are preferred, of which solution polymerization is more preferred so as to give an acrylic polymer having both excellent transparency and water resistance and to be performed inexpensively.

The solution polymerization may employ any of a variety of common solvents. The solvents are exemplified by organic solvents including esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methyl ethyl ketone and methyl isobutyl ketone. Each of them may be used alone or in combination.

The polymerization of the monomer components may employ a polymerization initiator. The polymerization initiator is exemplified by azo polymerization initiators such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), and dimethyl-2,2′-azobis(2-methyl propionate); and peroxide polymerization initiators such as benzoyl peroxide, t-butyl hydroperoxide, di-t-butyl peroxide, t-butyl peroxybenzoate, dicumyl peroxide, 1,1-bis(t-butylperoxy)-3,3,5-trimethylcyclohexane, and 1,1-bis(t-butylperoxy)cyclododecane. Each of them may be used alone or in combination. The polymerization initiator or initiators may be used in an amount not critical, as long as falling within such a conventional range as to be usable as a polymerization initiator.

The acrylic pressure-sensitive adhesive may further include one or more of other components in addition to the acrylic polymer. Such other components are exemplified by crosslinking agents, tackifiers, plasticizers, fillers, and antioxidants.

The crosslinking agents are exemplified by a variety of crosslinking agents such as epoxy compounds, isocyanate compounds, metal chelate compounds, metal alkoxides, metal salts, amine compounds, hydrazine compounds, and aldehyde compounds. Each of them may be selected and used according to a functional group contained in the acrylic polymer. Among them, isocyanate compounds are preferably used herein.

The isocyanate compounds are exemplified by aliphatic polyisocyanates such as 1,4-tetramethylene diisocyanate, 1,6-hexamethylene diisocyanate, and lysine diisocyanates; alicyclic polyisocyanates such as cyclopentyl diisocyanate, cyclohexyl diisocyanate, and isophorone diisocyanate; aromatic polyisocyanates such as 2,4-tolylene diisocyanate and 4,4′-diphenylmethane diisocyanate; and aromatic-aliphatic polyisocyanates such as xylylene-1,4-diisocyanate. The isocyanate compounds are further exemplified by dimers, trimers, reaction products, and polymerization products of the above-mentioned isocyanate compounds, such as trimethylolpropane/tolylene diisocyanate trimer adduct (trade name CORONATE L), trimethylolpropane/hexamethylene diisocyanate trimer adduct (trade name CORONATE HL), and isocyanurate form of hexamethylene diisocyanate (trade name CORONATE HX) (each supplied by Nippon Polyurethane Industry Co., Ltd.), polyether polyisocyanates, and polyester polyisocyanates. Each of them may be used alone or in combination.

The crosslinking agent(s) may be used in an amount of typically from 0.01 to 10 parts by weight, preferably from 0.05 to 5 parts by weight, and particularly preferably from 0.1 to 4 parts by weight, per 100 parts by weight of the acrylic polymer. The crosslinking agent(s), if used in an amount less than the range, may cause the pressure-sensitive adhesive component to be dissolved out typically into the electrolyte in the electrochemical device and may cause the electrochemical device to have inferior performance. In contrast, the crosslinking agent(s), if used in an amount greater than the range, may cause the pressure-sensitive adhesive layer to undergo whitening, to thereby have inferior transparency, and to have a poor appearance.

The pressure-sensitive adhesive layer may have a total thickness of typically from 2 to 100 μm, preferably from 2 to 50 μm, and particularly preferably from 2 to 20 μm. The pressure-sensitive adhesive layer, if having a thickness less than the range, may cause insufficient adhesiveness after thermopressure-bonding and may fail to prevent the active material from being detached. In contrast, the pressure-sensitive adhesive layer, if having a thickness greater than the range, may occupy an excessively large volume in the electrochemical device and may often hardly respond to reduction in size and weight of the electrochemical device. The pressure-sensitive adhesive layer for use herein may be a single layer or a laminate of two or more layers. When the pressure-sensitive adhesive layer is a laminate of two or more layers, the individual layers may have an identical composition or a combination of different compositions. When the pressure-sensitive adhesive tape includes two pressure-sensitive adhesive layers on both sides of the substrate, the two pressure-sensitive adhesive layers may have identical or different compositions.

Substrate

The substrate (backing) for use herein is exemplified by fibrous substrates, paper substrates, plastic substrates, rubber substrates, foams, and laminates of them. Materials for the plastic substrates are exemplified by polyesters such as poly(ethylene terephthalate)s, poly(ethylene naphthalate)s, poly(butylene terephthalate)s, and poly(butylene naphthalate)s; polyolefins such as polyethylenes, polypropylenes, and ethylene-propylene copolymers; poly(vinyl alcohol)s; poly(vinylidene chloride)s; poly(vinyl chloride)s; vinyl chloride-vinyl acetate copolymers; poly(vinyl acetate)s; polyamides; polyimides; celluloses; fluorocarbon resins; polyethers; poly(ether amide)s; poly(phenylene sulfide)s; styrenic resins such as polystyrenes; polycarbonates; and poly(ether sulfone)s.

Among them, plastic substrates made typically from polyimides, poly(phenylene sulfide)s, and polyolefins (e.g., polypropylenes) are preferably used herein. This is because these plastic substrates resist swelling even upon immersion in the electrolyte and less cause deterioration of the electrolyte. In particular, substrates of poly(phenylene sulfide)s and polypropylenes are preferred because they are available inexpensively.

The substrate may have undergone a common surface treatment on its surface as needed, so as to have better adhesion typically to the pressure-sensitive adhesive layer. The surface treatment is exemplified by chromate treatment, exposure to ozone, exposure to flame, exposure to a high-voltage electric shock, treatment with ionizing radiation, and other oxidation treatments by a chemical or physical technique.

The substrate may have a thickness not critical, but preferably from 8 to 100 μm, and more preferably from 10 to 50 μm. The substrate, if having a thickness less than the range, may cause the pressure-sensitive adhesive tape to have an insufficient strength and to have inferior practicality. In contrast, the substrate, if having a thickness greater than the range, may occupy an excessively large volume in the electrochemical device and may often hardly respond to reduction in size and weight of the electrochemical device.

Pressure-Sensitive Adhesive Tape for Electrochemical Devices

The pressure-sensitive adhesive tape for electrochemical devices according to the present invention includes the substrate and the pressure-sensitive adhesive layer on or over at least one side of the substrate. The pressure-sensitive adhesive tape for electrochemical devices according to the present invention can be formed by a known or common method. The method is exemplified by a method in which the pressure-sensitive adhesive to constitute the pressure-sensitive adhesive layer is diluted with a solvent as needed to give a coating composition (coating liquid), and the coating composition is directly applied onto the substrate to form the pressure-sensitive adhesive layer, where the solvent is exemplified by toluene, xylenes, ethyl acetate, and methyl ethyl ketone; and a transfer method in which the coating composition is applied onto a suitable separator (e.g., a release paper) to form a pressure-sensitive adhesive layer, and the formed pressure-sensitive adhesive layer is transferred onto the substrate. In the case of the transfer method, voids may remain at the interface between the substrate and the pressure-sensitive adhesive layer. In this case, the voids can be diffused and disappear by heating/pressurizing treatment such as autoclave treatment.

The application (coating) of the coating composition may be performed using a common coater such as rotogravure roll coater, reverse roll coater, kiss-contact roll coater, dip roll coater, bar coater, knife coater, spray coater, comma coater, and direct coater.

The pressure-sensitive adhesive tape may also be formed by melt extrusion of the substrate and the pressure-sensitive adhesive, where the pressure-sensitive adhesive will constitute the pressure-sensitive adhesive layer. The melt extrusion may be performed by any known process such as tubular film process or T-die process. After the extrusion, the extrude may be subjected to a stretching treatment. The stretching treatment is exemplified by uniaxial stretching in the machine direction (longitudinal direction) or in the transverse direction (cross direction); and sequential or simultaneous biaxial stretching in the machine and transverse directions.

The pressure-sensitive adhesive tape for electrochemical devices according to the present invention may bear a separator (release liner) on the surface of the pressure-sensitive adhesive layer. This may be performed from the viewpoints of the protection of the pressure-sensitive adhesive layer surface and the prevention of blocking. The separator will be removed upon application of the pressure-sensitive adhesive tape for electrochemical devices according to the present invention to an adherend and does not necessarily have to be provided. The separator to be used is not limited and may be selected typically from known or common release papers. In an embodiment, the pressure-sensitive adhesive tape for electrochemical devices according to the present invention is a double-coated pressure-sensitive adhesive tape. In this embodiment, the separator may be disposed on surfaces of the two pressure-sensitive adhesive layers of the pressure-sensitive adhesive tape for electrochemical devices according to the present invention. Alternatively, a separator having a backside release layer is prepared as the separator and is disposed on a surface of one pressure-sensitive adhesive layer, and the sheet (tape) is wound so as to allow the backside release layer of the separator to be in contact with a surface of the other pressure-sensitive adhesive layer.

The pressure-sensitive adhesive tape for electrochemical devices according to the present invention as obtained by the above-mentioned method has a first 180° peel adhesion strength and a second 180° peel adhesion strength. The first 180° peel adhesion strength is measured at a peeling temperature of 25° C. and a peeling speed of 300 mm/min after pressure-bonding of the tape to a SUS 304BA plate at a temperature of from 40° C. to below 150° C. The second 180° peel adhesion strength is measured at a peeling temperature of 25° C. and a peeling speed of 300 mm/min after pressure-bonding of the tape to a SUS 304BA plate at 25° C. The pressure-bonding may be performed by pressing typically with a pressing force of from 0.5 to 10 kg/cm². The first 180° peel adhesion strength is twice or more, preferably three times or more, particularly preferably five times or more, and most preferably ten times or more as high as the second 180° peel adhesion strength.

The pressure-sensitive adhesive tape for electrochemical devices according to the present invention as obtained by the above-mentioned method may have a second 180° peel adhesion strength of typically from 0.05 to 2 N/10 mm, preferably from 0.05 to 1.8 N/10 mm, particularly preferably from 0.05 to 1.7 N/10 mm, where the second 180° peel adhesion strength is measured at a peeling temperature of 25° C. and a peeling speed of 300 mm/min after pressure-bonding of the tape to a SUS 304BA plate at 25° C., where the pressure-bonding may be performed typically by pressing with a pressing force of from 0.5 to 10 kg/cm².

The pressure-sensitive adhesive tape for electrochemical devices according to the present invention obtained by the above-mentioned method has a probe tack of typically 5 N or less, preferably from 0.1 to 5.0 N, and particularly preferably from 0.5 to 4.0 N at room temperature (25° C.). The pressure-sensitive adhesive tape enables temporary fixing at room temperature and can thereby be once removed and applied again typically when air bubbles are included upon application. This may prevent reduction in yield. The probe tack herein refers to a value measured using a tack tester (supplied by RHESCA Co., Ltd.) under conditions as follows.

Measurement Conditions
Temperature: 25° C.
Probe material: SUS
Probe shape: cylindrical (5 mm in diameter)
Pressing speed: 30 mm/min
Measurement (Separating) speed: 30 mm/min
Preload: 100 gf
Pressing time: 1 second

Electrochemical Device Production Method

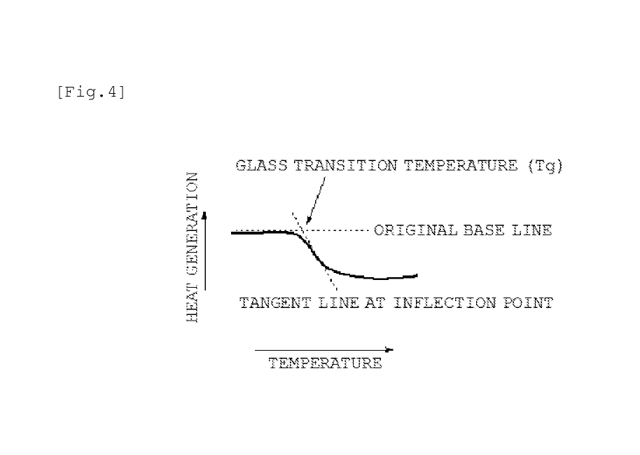

The method for producing an electrochemical device according to the present invention includes following steps 1 to 3 (see FIG. 3).

In the step 1, a current collector is partially coated with an active material to give an active material-current collector composite.

In the step 2, the pressure-sensitive adhesive tape for electrochemical devices is applied to a boundary area of a portion coated with the active material and an uncoated portion in the active material-current collector composite by pressure-bonding at a temperature of from 40° C. to below 150° C.

In the step 3, the active material-current collector composite bearing the pressure-bonded pressure-sensitive adhesive tape for electrochemical devices is cut and/or blanked.

Typically, the cathode (positive electrode) of a lithium-ion battery employs aluminum foil as a current collector, and lithium cobaltate as a cathode active material. The anode (negative electrode) employs copper foil as a current collector, and a carbon material or a composite of the carbon material with a tin compound or silicon as an anode active material. The carbon material is exemplified by graphite, carbon nanotubes, and fullerenes.

The pressure-bonding of the pressure-sensitive adhesive tape for electrochemical devices in the step 2 is performed at a temperature of from 40° C. to below 150° C., preferably from 60° C. to 140° C., and particularly preferably from 70° C. to 130° C. The pressure-sensitive adhesive tape, if pressure-bonded at a temperature lower than the range, may often hardly exhibit a sufficient adhesive strength. In contrast, the pressure-sensitive adhesive tape, if pressure-bonded at a temperature higher than the range, may ooze upon pressure-bonding to cause inferior workability.

In the step 3, the active material-current collector composite bearing the pressure-bonded pressure-sensitive adhesive tape for electrochemical devices may be cut and/or blanked at a temperature of preferably below 40° C., and particularly preferably at room temperature (e.g., from 5° C. to 35° C.). A cutting blade for use in the cutting is not limited and can be selected from cutting blades for use in cutting/blanking in electrochemical device production. The cutting blades are exemplified by one under the trade name of NT Spare Blade DISPENSER A (supplied by NT Inc.).

Electrodes, i.e., a cathode and an anode, are obtained through the step 3. A separator is disposed between the cathode and the anode, and the resulting stack is wound as a cylinder or an ellipsoidal cylinder to give a coiled bundle of electrodes. The cathode and anode are, at their predetermined portions, connected respectively with a cathode lead and an anode lead by welding and encapsulated together with an electrolyte in a casing to give an electrochemical device.

The method for producing an electrochemical device according to the present invention employs the pressure-sensitive adhesive tape for electrochemical devices as a pressure-sensitive adhesive tape for preventing active materials from being detached. The pressure-sensitive adhesive tape, after thermopressure-bonding at a temperature from 40° C. to below 150° C., exhibits a high adhesive strength to prevent the active materials from being detached. Even after being heated once, the pressure-sensitive adhesive has appropriate stiffness at around room temperature and less undergoes adherence or deposition to the cutting blade. Thus, the method enables extremely efficient production of the electrochemical device.

In an embodiment, the pressure-sensitive adhesive tape for electrochemical devices to be used contains one or more high-Tg monomers and one or more low-Tg monomers in contents within the specific ranges. In this embodiment, the pressure-sensitive adhesive tape can perform temporary fixing at room temperature, and can be once removed and applied again typically when air bubbles are included upon application. The method using the pressure-sensitive adhesive tape can thereby prevent yield reduction due to misapplication of the pressure-sensitive adhesive tape.

### EXAMPLES

The present invention will be illustrated in further detail with reference to several examples below. It should be noted, however, that the examples are by no means intended to limit the scope of the present invention.

### Example 1

Materials were prepared as 81.3 parts by weight of butyl acrylate (BA), 6.5 parts by weight of methyl methacrylate (MMA), 12.2 parts by weight of acrylic acid (AA), 0.1 part by weight of 2,2′-azobisisobutyronitrile (AIBN) as an initiator, and 100 parts by weight of toluene as a solvent. The materials were mixed and placed under a nitrogen (N₂) purge for 2 hours. The resulting mixture was subjected to polymerization at 60° C. for 6 hours and yielded an acrylic copolymer (1) having an acid value of 94 KOH-mg/g. The acrylic copolymer (1) (100 parts by weight) was combined with 1 part by weight of an isocyanate crosslinking agent (trade name CORONATE L, supplied by Nippon Polyurethane Industry Co., Ltd.) and diluted with toluene, which yields a coating composition (1).

The resulting coating composition (1) was applied onto a 20-μm thick polypropylene film (OPP) (trade name TORAYFAN B02548, supplied by Toray Industries Inc.) to a dry thickness of 10 μm and dried, which yields a pressure-sensitive adhesive tape (1).

### Example 2

Materials were prepared as 79.3 parts by weight of butyl acrylate (BA), 4.8 parts by weight of vinyl acetate (VAc), 15.9 parts by weight of acrylic acid (AA), 0.1 part by weight of 2,2′-azobisisobutyronitrile (AIBN) as an initiator, and 100 parts by weight of toluene as a solvent. The materials were mixed and placed under a nitrogen (N₂) purge for 2 hours. The resulting mixture was subjected to polymerization at 60° C. for 6 hours and yielded an acrylic copolymer (2) having an acid value of 124 KOH-mg/g.

Except for using the acrylic copolymer (2) instead of the acrylic copolymer (1), a pressure-sensitive adhesive tape (2) was prepared by the procedure of Example 1.

### Example 3

Materials were prepared as 26.3 parts by weight of ethyl acrylate (EA), 61.4 parts by weight of 2-ethylhexyl acrylate (2-EHA), 8.8 parts by weight of N-phenylmaleimide (PMI), 3.5 parts by weight of 2-hydroxyethyl acrylate (HEA), 0.1 part by weight of 2,2′-azobisisobutyronitrile (AIBN) as an initiator, and 100 parts by weight of toluene as a solvent. The materials were mixed and placed under a nitrogen (N₂) purge for 2 hours. The resulting mixture was subjected to polymerization at 60° C. for 6 hours and yielded an acrylic copolymer (3).

Except for using the acrylic copolymer (3) instead of the acrylic copolymer (1), a pressure-sensitive adhesive tape (3) was prepared by the procedure of Example 1.

### Comparative Example 1

Materials were prepared as 95.2 parts by weight of 2-ethylhexyl acrylate (2-EHA), 4.8 parts by weight of acrylic acid (AA), 0.1 part by weight of 2,2′-azobisisobutyronitrile (AIBN) as an initiator, and 100 parts by weight of toluene as a solvent. The materials were mixed and placed under a nitrogen (N₂) purge for 2 hours. The resulting mixture was subjected to polymerization at 60° C. for 6 hours and yielded an acrylic copolymer (4) having an acid value of 37 KOH-mg/g.

Except for using the acrylic copolymer (4) instead of the acrylic copolymer (1), a pressure-sensitive adhesive tape (4) was prepared by the procedure of Example 1.

The pressure-sensitive adhesive tapes obtained in the examples and comparative example were evaluated on probe tack, adhesive strength, and deposition onto the cutting blade by methods as follows.

Probe Tack Measurement Method

Each of the pressure-sensitive adhesive tapes obtained in the examples and comparative example was fixed onto a glass plate with a double-coated pressure-sensitive adhesive tape disposed between the glass plate and the substrate of the adhesive tape to be measured. A probe of the tack tester (supplied by RHESCA Co., Ltd.) was pressed to the pressure-sensitive adhesive tape to be measured and then separated therefrom under conditions as follows. The adhesive strength (N) in the separation process was measured.

Measurement Conditions
Temperature: 25° C.
Probe material: SUS
Probe shape: cylindrical (5 mm in diameter)
Pressing speed: 30 mm/min
Measurement (separation) speed: 30 mm/min
Preload: 100 gf
Pressing time: 1 second

Adhesive Strength Measurement Method

Each of the pressure-sensitive adhesive tapes (10 mm wide and 100 mm long) obtained in the examples and comparative example was pressure-bonded to a SUS 304BA plate using a heat pressing machine (trade name TP-701-B Heat Seal Tester, Temperature Control from Upper and Lower Sides, supplied by TESTER SANGYO CO., LTD.), left stand at 25° C. for 30 minutes or longer, and a 180° peel adhesion strength, or an adhesion strength upon peeling at an angle of 180-degree, at 25° C. in N/10 mm was measured.

Pressure-bonding Conditions
Temperature: 25° C. or 80° C.
Pressure: 0.4 MPa
Pressing Time: 1 seconds

Evaluation Method of Deposition onto Cutting Blade

Each of the pressure-sensitive adhesive tapes obtained in the examples and comparative example was processed into a 15-mm wide strip and pressure-bonded to aluminum foil (trade name nippaku foil, supplied by Nippon Foil Mfg. Co., Ltd.) under following conditions, and the resulting article was subjected to cutting hundreds of times at intervals of 10 mm from the substrate side of the pressure-sensitive adhesive tape using a cutting blade (trade name NT Spare Blade DISPENSER A, supplied by NT Inc.), whether or how the pressure-sensitive adhesive was deposited onto the cutting blade was visually inspected, and the deposition was evaluated according to criteria as follows.

Pressure-Bonding Conditions
Temperature: 80° C.
Pressure: 0.4 MPa
Pressing time: 1 second

Criteria

Excellent: No pressure-sensitive adhesive was deposited onto the cutting blade through two hundred cuttings;

Good: No pressure-sensitive adhesive was deposited onto the cutting blade till the cutting from the 100^{th} cutting to the 199^{th} cutting; and

Poor: The pressure-sensitive adhesive was deposited onto the cutting blade not later than the 100^{th} cutting.

The results of the evaluations are summarized and shown in Table 1 below.

TABLE 1

| | | | | | | Comparative |
|---|---|---|---|---|---|---|
| | | | Example 1 | Example 2 | Example 3 | Example 1 |
| Pressure- | Low-Tg monomer | BA | 81.3 | 79.3 | — | — |
| sensitive | | EA | — | — | 26.3 | — |
| adhesive | | 2-EHA | — | — | 61.4 | 95.2 |
| | | HEA | — | — | 3.5 | — |
| | High-Tg monomer | MMA | 6.5 | — | — | — |
| | | VAc | — | 4.8 | — | — |
| | | AA | 12.2 | 15.9 | — | 4.8 |
| | | PMI | — | — | 8.8 | — |
| | CORONATE L | | 1 | 1 | 1 | 1 |
| Substrate | OPP thickness (μm) | | 20 | 20 | 20 | 20 |
| Properties | Probe tack (at 25° C., in N) | | 1.13 | 2.50 | 3.46 | 5.10 |
| | Adhesive strength | Pressure-bonding | 1.63 | 0.22 | 0.40 | 1.75 |
| | (25° C. in N/10 mm) | at 25° C. | | | | |
| | | Pressure-bonding | Substrate | 2.69 | 1.45 | 0.89 |
| | | at 80° C. | failure (>4) | | | |

| | | | | |
|---|---|---|---|---|
| Deposition on cutting blade | Good | Good | Excellent | Poor (deposition |
| | | | | upon 10th cutting) |

### INDUSTRIAL APPLICABILITY

The pressure-sensitive adhesive tape for electrochemical devices according to the present invention, upon application by thermopressure-bonding, can exhibit a high adhesive strength and, at room temperature, less causes the pressure-sensitive adhesive to deposit onto the cutting blade even upon cutting. This enables extremely efficient production of an electrochemical device without staining the cutting blade. Specifically, in a production process of the electrochemical device, a large-sized current collector is coated partially with an active material, the pressure-sensitive adhesive tape for electrochemical devices according to the present invention is applied by thermopressure-bonding to an area across the boundary between a portion coated with the active material and an uncoated portion, and the resulting current collector is cut to a desired size at room temperature.

### REFERENCE SIGNS LIST

1 substrate

2, 21, 22 pressure-sensitive adhesive layer

3, 31, 32 pressure-sensitive adhesive tape for electrochemical devices

4 current collector

5 active material

6 portion to be cut

7 electrode

1. A pressure-sensitive adhesive tape for electrochemical devices in production thereof, the pressure-sensitive adhesive tape comprising:
a substrate, and
a pressure-sensitive adhesive layer on or over at least one side of the substrate, the pressure-sensitive adhesive layer comprising an acrylic polymer as a base polymer,
the pressure-sensitive adhesive tape having a first 180° peel adhesion strength and a second 180° peel adhesion strength, the first 180° peel adhesion strength being measured at a peeling temperature of 25° C. and a peeling speed of 300 mm/min after pressure-bonding of the tape to a SUS 304BA plate at a temperature of from 40° C. to below 150° C., the second 180° peel adhesion strength being measured at a peeling temperature of 25° C. and a peeling speed of 300 mm/min after pressure-bonding of the tape to a SUS 304BA plate at a temperature of 25° C.,
the first 180° peel adhesion strength being twice or more as high as the second 180° peel adhesion strength.

2. The pressure-sensitive adhesive tape for electrochemical devices according to claim 1, wherein the acrylic polymer is derived from monomer components comprising one or more monomers each of which gives a homopolymer having a glass transition temperature of 10° C. or higher, a total content of the one or more monomers is 5 wt % or more based on the total amount (100 wt %) of the monomer components.

3. The pressure-sensitive adhesive tape for electrochemical devices according to claim 1, wherein the acrylic polymer is derived from monomer components comprising one or more monomers each of which gives a homopolymer having a glass transition temperature of below 10° C., a total content of the one or more monomers being from 65 to 94 wt % based on the total amount (100 wt %) of the monomer components.

4. The pressure-sensitive adhesive tape for electrochemical devices according to claim 1, wherein the acrylic polymer is derived from monomer components comprising one or more carboxy group-containing monomers, a total content of the one or more carboxy group-containing monomers being 2 wt % or more based on the total amount (100 wt %) of the monomer components.

5. A method for producing an electrochemical device, the method comprising the steps of:
coating a current collector partially with an active material to give an active material-current collector composite;
pressure-bonding the pressure-sensitive adhesive tape for electrochemical devices according to claim 1 to a boundary area of a portion coated with the active material and an uncoated portion in the active material-current collector composite, the pressure-bonding being performed at a temperature of from 40° C. to below 150° C.; and
cutting and/or blanking the active material-current collector composite bearing the pressure-bonded pressure-sensitive adhesive tape for electrochemical devices.

6. An electrochemical device produced by the method for producing an electrochemical device according to claim 5.
